(19) United States
(12) Patent Application Publication
(10) Pub. No.: US 2026/0338152 A1
(43) Pub. Date: Oct. 29, 2026

(54) HYDRAULIC TURBINE RUNNER

(71) Applicant: Natel Energy Holdings, Inc., Alameda, CA (US)

(72) Inventors: Abraham D. SCHNEIDER, San Francisco, CA (US); Sterling Marina WATSON, San Francisco, CA (US)

(21) Appl. No.: 19/099,708

(22) PCT Filed: Aug. 30, 2024
(86) PCT No.: PCT/US2024/044908

§ 371 Date: Jan. 29, 2025

Related U.S. Application Data
(60) Provisional application No. 63/536,264, filed on Sep. 1, 2023.

(51) Int. Cl. F03B 3/12

(52) U.S. Cl. CPC F03B 3/121; F03B 3/126

(57) ABSTRACT

A runner for a hydraulic turbine configured to reduce fish mortality. The runner includes a hub and a plurality of blades extending from the hub. Each blade includes a root connected to the hub and a tip opposite the root. Each blade further includes a leading edge opposite a trailing edge.

### CROSS-REFERENCE TO RELATED APPLICATIONS

The present applications claims priority to U.S. Provisional Application No. 63/536,264, filed Sep. 1, 2023, which is incorporated herein by reference in its entirety.

### FIELD OF THE INVENTION

The present invention relates to a hydroelectric turbine runner. Specifically, the present invention relates to a turbine runner configured to promote safe downstream passage of fish through the turbine.

### BACKGROUND OF THE INVENTION

There is an increasing need for hydropower plants that have a low impact on the environment. In order to reduce environmental impact, it is desirable for hydropower plants to have a minimal effect on fish and other aquatic wildlife (e.g., by not harming fish and by avoiding blocking the travel or migration of fish). It is also desirable to construct hydropower plants that have high efficiency and relatively low installation, operation, and maintenance costs. It is also sometimes desirable to retrofit existing hydropower plants with new turbines for reduced environmental impact and/or improved efficiency.

Accordingly, there is a continuing need in the art for a turbine that allows for safe downstream passage of fish through the turbine and that has high efficiency, that has relatively low installation, operation, and maintenance costs, and that can be used in a wide range of applications, including retrofit installations.

### BRIEF SUMMARY OF THE INVENTION

As discussed herein, a runner for a hydraulic turbine can include a hub and a plurality of blades extending from the hub. Each blade of the plurality of blades can include a root located at the hub, a tip opposite the root, a leading edge, and a trailing edge opposite the leading edge. The runner can be configured to rotate about a rotation axis. Each blade of the plurality of blades can have a leading edge midpoint along the leading edge of the blade and a trailing edge midpoint along the trailing edge of the blade. A surface swept from a circle intersecting the leading edge midpoints of the blades to a circle intersecting the trailing edge midpoints of the blades can have a frustoconical shape. A lateral surface of the frustoconical shape and an axis parallel to the rotation axis of the runner can define a mean diagonal angle αₘ therebetween. At least one blade can include a ratio of a thickness of the leading edge to a diameter of the runner at a downstream side of runner, TLE/DR, that is greater than approximately 0.03. For the at least one blade, the leading edge at the root can be positioned along a radial axis of the runner and the leading edge at the tip can be cantilevered beyond the radial axis in a circumferential direction of the runner. A maximum leading edge thickness of the at least one blade can be at least approximately 50 mm. A maximum leading edge thickness of the at least one blade can be at least approximately 100 mm. A maximum leading edge thickness of the at least one blade can be at least approximately 200 mm. The mean diagonal angle αₘ can be greater than 0 degrees and less than 90 degrees. The mean diagonal angle αₘ can be between approximately 2 degrees and approximately 45 degrees. The mean diagonal angle αₘ can be between approximately 20 degrees and approximately 35 degrees. The runner can include an outer rim connecting the blade tips around a circumference of the runner. The leading edge thickness of at least one of the blades at the blade tip can be larger than the leading edge thickness at the blade root. The plurality of blades can include three or more blades. The leading edge of at least one of the blades can be saddle-shaped. A portion of the leading edge at the blade tip of at least one of the blades can be slanted forward in a direction of blade rotation. The portion of the leading edge at the blade tip can be slanted at an angle ranging from about 20 degrees to about 90 degrees. The portion of the leading edge at the blade tip can be slanted at an angle ranging from about 25 degrees to about 45 degrees. The runner can be positioned within a turbine housing having an inlet and outlet for a flow of water.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1A is a perspective view of a runner for a hydraulic turbine according to an embodiment.

FIG. 1B is a side view of the runner according to FIG. 1A.

FIG. 1C is an upstream view of the runner according to FIG. 1A.

FIG. 2A is a perspective view of a runner for a hydraulic turbine according to an embodiment.

FIG. 2B is a side view of the runner according to FIG. 2A.

FIG. 2C is an upstream view of the runner according to FIG. 2A.

FIG. 3A is a perspective view of a runner for a hydraulic turbine according to an embodiment.

FIG. 3B is a side view of the runner according to FIG. 3A.

FIG. 3C is an upstream view of the runner according to FIG. 3A.

FIG. 4A is a perspective view of a runner for a hydraulic turbine according to an embodiment.

FIG. 4B is a side view of the runner according to FIG. 3A.

FIG. 4C is an upstream view of the runner according to FIG. 3A.

FIG. 5A is a perspective view of a runner for a hydraulic turbine according to an embodiment.

FIG. 5B is an upstream view of the runner according to FIG. 5A.

FIG. 6A is a perspective view of a runner for a hydraulic turbine according to an embodiment.

FIG. 6B is an upstream view of the runner according to FIG. 6A.

FIG. 7A is a perspective view of a runner for a hydraulic turbine according to an embodiment.

FIG. 7B is a perspective view of a runner for a hydraulic turbine according to an embodiment.

FIG. 8A is a side perspective view of a runner for a hydraulic turbine in a turbine housing according to an embodiment.

FIG. 8B is a cross-sectional view taken along E-E of a blade of the runner according to FIG. 8A.

FIG. 8C is an axial section view of a blade of the runner according to FIG. 8A.

FIG. 9A is a side perspective view of a runner for a hydraulic turbine according to an embodiment.

FIG. 9B is a cross-sectional view taken along F-F of a blade of the runner according to FIG. 9A.

FIG. 9C is an axial section view of a blade of the runner according to FIG. 9A.

FIG. 10A is a side perspective view of a runner for a hydraulic turbine according to an embodiment.

FIG. 10B is a cross-sectional view taken along G-G of a blade of the runner according to FIG. 10A.

FIG. 10C is an axial section view of a blade of the runner according to FIG. 10A.

### DETAILED DESCRIPTION OF THE INVENTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the terms “about” or “approximately” may refer to the stated amount or value +/−5%.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Modern hydropower facilities often must satisfy rigorous criteria for environmental sustainability. In many cases, hydropower plants using runners that are unsafe for downstream passage of fish or other aquatic organisms need to be equipped with systems to exclude fish from entering the turbine, or else the turbines need to be turned off during fish migration seasons. Typical fish exclusion systems can include screens built from bars having very small clear spacing (for example, 10 mm or 19 mm bar spacing). Such systems are expensive to build and difficult to keep clean, and when installed into an existing hydropower facility, the exclusion screen can incur significant additional loss of energy due to hydraulic head loss. Above a certain flow rate, such as about 75-100 m³/s, fish exclusion screens are generally considered impractical to install, and yet turbines operating at such large flow rates may be just as dangerous to entrained fish, as smaller turbines.

Hydropower plants operating at a head of about 60 meters or less often disturb natural ecosystems, particularly by disrupting upstream and downstream fish movements. However, hydropower development in this range is still desirable due to the relative availability of such installation sites. Medium-head applications (e.g., head greater than 30 meters) are particularly desirable due to the relatively greater power density at these sites as compared to lower-head sites.

The majority of hydropower generating capacity in the United States is found at plants below 40 meters of head. The majority of existing hydropower facilities in the United States and European regions were first constructed before 1975. Typically, hydropower runners require significant maintenance at an interval between 25-50 years. Thus, a large need exists for repair or replacement of hydropower turbine runners today. It would be of large economic benefit to hydropower plant owners to install replacement runners which are safe for the downstream passage of fish, while maintaining high efficiency and compatibility with the existing hydropower plant civil and electrical infrastructure (e.g., intake works, draft tube, and generator).

Some embodiments described herein provide a runner for a hydraulic turbine for low-head, medium-head, or high-head applications which allows for safe downstream passage of fish through a turbine incorporating the runner. Embodiments described herein also achieve high efficiency and have relatively low installation, operation, and maintenance costs. Some embodiments described herein can be used in a wide range of applications, including retrofit installations.

In some embodiments, the runner includes a plurality of blades. The plurality of blades may be fixed to the hub. Each of the plurality of blades has a leading edge midpoint along a leading edge of the blade and a trailing edge midpoint along a trailing edge of the blade. Each of the plurality of blades has a midline defined as a middle portion between a root and a tip of the blade. For example, the midline may intersect a midpoint between root and tip on a leading edge and a midpoint between the root and the tip on the trailing edge. A surface swept from a circle intersecting the leading edge midpoints of the blades of the runner to a circle intersecting the trailing edge midpoints of the blades of the runner can have a frustoconical shape.

In some embodiments, a lateral surface of the frustoconical shape and an axis parallel to a rotation axis of the runner define a mean diagonal angle αₘ therebetween. In some embodiments, the mean diagonal angle αₘ is greater than 0 degrees and less than 90 degrees. In some embodiments, the mean diagonal angle αₘ is between approximately 2 degrees and approximately 45 degrees. In some embodiments, the mean diagonal angle αₘ is between approximately 20 degrees and approximately 35 degrees.

In some embodiments, the runner is a Deriaz-type turbine runner. In such embodiments, a surface swept from a circle intersecting the leading edge midpoints of the blades of the Deriaz-type turbine runner to a circle intersecting the trailing edge midpoints of the blades of the Deriaz-type turbine runner can have a frustoconical shape as described above. In such embodiments, the Deriaz-type turbine runner can have a mean diagonal angle αₘ that is greater than 0 degrees and less than 90 degrees, such as between approximately 2 degrees and approximately 45 degrees, such as between approximately 20 degrees and approximately 35 degrees.

In some embodiments, the runner is a Francis-type turbine runner. In such embodiments, a surface swept from a circle intersecting the leading edge midpoints of the blades of the Francis-type turbine runner to a circle intersecting the trailing edge midpoints of the blades of the Francis-type turbine runner can have a frustoconical shape as described above. In such embodiments, the Francis-type turbine runner can have a mean diagonal angle αₘ that is greater than 0 degrees and less than 90 degrees, such as between approximately 2 degrees and approximately 45 degrees, such as between approximately 20 degrees and approximately 35 degrees.

Runner 100 can be configured to receive an inflow of water at an average angle greater than 0 degrees and less than 90 degrees relative to shaft axis 150. For example, runner 100 can be configured to receive an inflow of water at an average angle relative to shaft axis 150 of between approximately 2 degrees and approximately 75 degrees. In some embodiments (for example, for low head applications), runner 100 can be configured to receive an inflow of water at an average angle of between approximately 2 degrees and approximately 15 degrees, such as between approximately 2 degrees and approximately 10 degrees, such as between approximately 2 degrees and approximately 5 degrees. In some embodiments (for example, for high head applications), runner 100 can be configured to receive an inflow of water at an average angle of between approximately 20 degrees and approximately 75 degrees, such as between approximately 20 degrees and approximately 60 degrees, such as between approximately 20 degrees and approximately 45 degrees.

Runner 100 can be configured to output water in a direction generally parallel to shaft axis 150. In some embodiments, the water leaving the runner can have a complex mix of velocity components including variations in swirl, which can aid in maintaining good pressure recovery within the draft tube.

In some embodiments, a blade of the runner has a thick leading edge relative to the size of fish allowed to pass through the turbine. Fish survival after a blade strike event is sensitive to the ratio of fish body length to the thickness of the turbine blade leading edge and speed. For example, blades with a fish length to blade thickness ratio <1 can allow for a fish survival rate of approximately 100% following a blade strike at a strike speed of 7 m/s and >approximately 90% at strike speed of 12 m/s. As a result, a fish that encounters a blade having a thick leading edge is more likely to survive a blade impact relative to a fish that encounters a blade having a thinner leading edge.

Additionally, in some embodiments, the leading edge thickness of the runner is greater at a tip of the runner blade than it is at a hub of the runner blade. In this way, the protective effect of a thick leading edge is greatest in a region where blade speeds are highest.

In some embodiments, a leading edge of a blade of the runner is slanted forward relative to a radial axis of the runner in a direction of rotation, also referred to as cantilever or forward “lean”. As a result, the orthogonal component w_{N} of the strike velocity is reduced, thereby reducing fish mortality from an impact with the blade.

In some embodiments, the runner is incorporated into a turbine.

These and other embodiments are discussed below in more detail with reference to the figures.

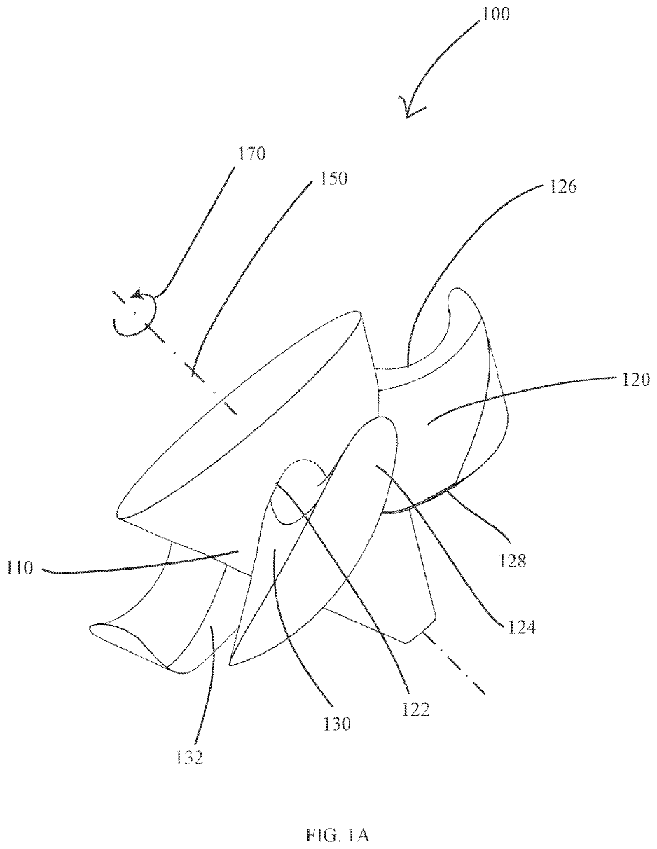

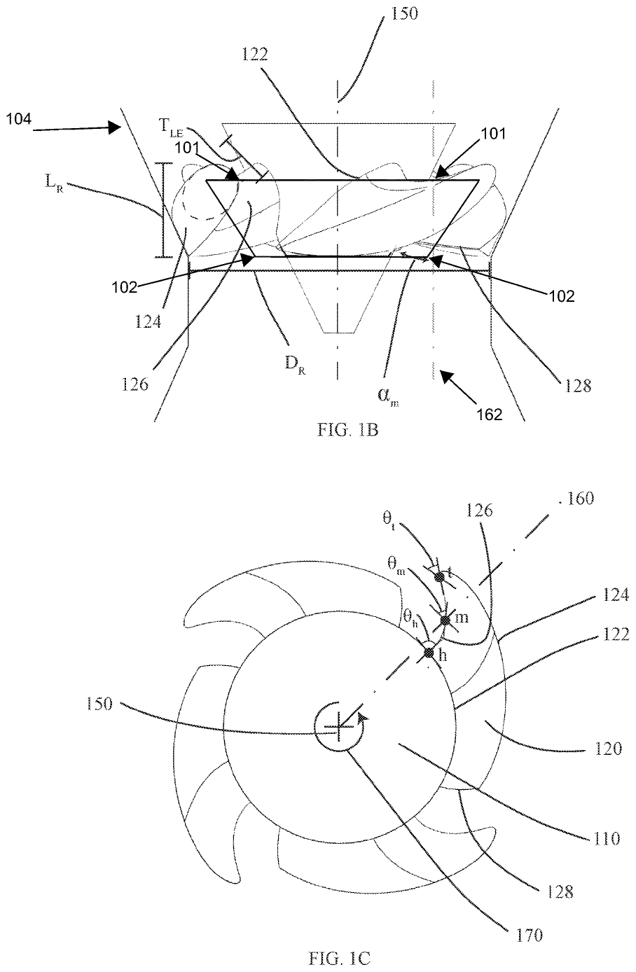

FIGS. 1A-1C show a runner 100 according to some embodiments. FIG. 1A shows a perspective view of runner 100, FIG. 1B shows a side view of runner 100, and FIG. 1C shows an upstream view of runner 100.

Runner 100 can be configured to rotate in a circumferential direction 170 about shaft axis 150 during use in order to drive a generator. In the embodiment shown in FIG. 1C, for example, circumferential direction 170 is counterclockwise when viewed from an upstream side of runner 100. However, in other embodiments, circumferential direction 170 can be clockwise when viewed from an upstream side of runner 100.

Runner 100 can include a hub 110 and a plurality of blades 120 extending radially from hub 110.

Blades 120 can be evenly spaced about a circumference of hub 110. In some embodiments, blades 120 are arranged helically on hub 110. In some embodiments, each of the plurality of blades 120 of runner 100 has the same shape and dimensions.

In the embodiment illustrated in FIG. 1A, runner 100 includes four blades 120. However, in other embodiments, runner 100 can include two blades, three blades, five blades, or more than five blades.

Each blade 120 of runner 100 can include a root 122 located at hub 110, a tip 124 opposite root 122 and defining an outermost extent of blade 120, a leading edge 126 at an upstream portion of runner 100, a trailing edge 128 at a downstream portion of runner 100, a pressure surface 130 on an upstream side of blade 120, and a suction surface 132 on a downstream side of blade 120.

In some embodiments, the shape of runner 100 at blade tips 124 corresponds to the shape of a turbine 200 housing in which runner 100 can be used. For example, in some embodiments, an associated turbine housing can have a frustoconical shape that tapers inward from an upstream side of the turbine housing to a downstream side of the turbine housing, and an outermost extent of blade tips 124 can have a corresponding taper from an inlet side of runner 100 to an outlet side of runner 100. As another example, in some embodiments, as associated turbine housing can have a cylindrical shape, and an outermost extent of blade tips 124 can have a corresponding cylindrical shape.

In some embodiments, each blade 120 has a leading edge midpoint along leading edge 126 of blade 120 and a trailing edge midpoint along trailing edge 128 of blade 120. As shown in FIG. 1B, a surface swept from a circle intersecting the leading edge midpoints 101 of blades 120 of runner 100 to a circle intersecting the trailing edge midpoints 102 of blades 120 of runner 100 can have a frustoconical shape. The circle intersecting leading edge midpoints 101 and trailing edge midpoints 102 may be traced by midpoints 101, 102 as runner 100 rotates about shaft axis 150 (i.e., runner 100 rotates in a circle).

As also shown in FIG. 1B, a lateral surface of the frustoconical shape and an axis 162 parallel to a rotation axis of runner 100 can define a mean diagonal angle αₘ therebetween, In the embodiment illustrated in FIG. 1B, the mean diagonal angle αₘ is 25.5 degrees. However, in other embodiments, the mean diagonal angle αₘ can be another angle greater than 0 degrees and less than 90 ninety degrees. For example, in some embodiments, the mean diagonal angle αₘ can be between approximately 2 degrees and approximately 45 degrees. In some embodiments, the mean diagonal angle αₘ is between approximately 5 degrees and approximately 35 degrees. In some examples, the mean diagonal angle αₘ is between about 9 degrees and about 23 degrees. A mean diagonal angle αₘ between about 9 degrees and about 23 degrees may allow the blades to have a longer chord length relative to blades with larger mean diagonal angles αₘ. The longer chord length increases the blade surface area and improves pressure distribution while maintaining efficiency.

As shown, for example, in FIG. 1B, blade 120 can have a thick leading edge 126 with a thickness T_{LE}.

In some embodiments, leading edge thickness T_{LE} of blade 120 can be at least approximately 50 mm. In some embodiments, leading edge thickness T_{LE} of blade 120 can be the same as or greater than a length of a fish species of interest in the region in which a turbine including runner 100 is to be installed. For example, salmon smolt have a length that is an average of about 100 mm to 200 mm. Accordingly, the leading edge thickness T_{LE} of blade 120 intended to be used in a region with salmon smolt can be 100 mm to 200 mm or more.

In other embodiments, the ratio of leading edge thickness T_{LE} to runner diameter at a downstream side of the runner D_{R} (i.e., T_{LE}/D_{R}) can be approximately 0.03 to approximately 0.2, such as approximately 0.08 to approximately 0.17, such as approximately 0.11 to approximately 0.14.

In some embodiments, the thickness of blade 120 can taper from leading edge 126 toward trailing edge 128. Thickness of blade 120 can be tapered such that pressure surface 130 and suction surface 132 intersect at a point, or at a surface with very small thickness, at trailing edge 128 of blade 120.

In some embodiments, blade 120 can have a consistent thickness from root 122 to tip 124. In other embodiments, the thickness of blade 120 can be variable. In some embodiments, the thickness of blade 120 can be greater at tip 124 of blade 120 than at hub 110. The tangential velocity of blade 120 increases from root 122 to tip 124. As a result, the orthogonal component of strike velocity of blade 120 encountering fish 300 near tip 124 may be greater than the orthogonal component of strike velocity of blade 120 encountering fish 300 near root 122. To reduce risk of mortality in regions where fish 300 is most likely to experience high strike velocities, the blade can have a thick leading edge and additionally or alternatively a slanted leading edge, as will be discussed.

As shown, for example, in FIG. 1C, blade 120 of runner 100 can have a leading edge 126 that is slanted at an angle θ at one or more locations (e.g., locations t, m, h) along leading edge 126. (A curve can be drawn along the apex of the stagnation region of the blade from hub to tip, defining the leading edge of the blade. A tangent line drawn at any point along this curve, can be measured relative to a cylindrical surface, coaxial with the turbine runner rotation axis, which intersects the point. The slant angle is measured between the tangent line, and a vector lying on the cylindrical surface, perpendicular to the leading edge and coincident with the leading edge intersection point.)

Fish mortality is a function of the normal component w_{N} of the strike velocity at impact. Therefore, reducing the normal component w_{N} of the strike velocity at impact results in reduced fish mortality. Accordingly, fish mortality is reduced relative to a blunt blade at leading edge locations having a slant angle θ other than 90 degrees.

In some embodiments, leading edge 126 at a location can be slanted at an angle θ of about 25 to about 50 degrees. In some embodiments, leading edge 126 at a location can be slanted at an angle θ of about 30 degrees.

In some embodiments, leading edge 126 can be slanted at tip 124. As mentioned, strike speed increases from root 122 of blade 120 to tip 124 of blade 120, such that tip 124 of blade 120 has the greatest strike speed. Accordingly, providing leading edge 126 with a slant angle θ at tip 124 of blade 120 can reduce mortality where fish 300 would otherwise be more likely to experience a fatal impact. Providing a slanted leading edge 126 at tip 124 can also, for example, help to prevent build-up or accumulation of debris at tip 124. A slanted leading edge 126 at tip 124 can also help to mitigate the onset of cavitation.

In some embodiments, leading edge 126 can be slanted at a location between root 122 and tip 124. For the same reasons discussed above with respect to providing leading edge 126 with a slant angle at tip 124, providing leading edge 126 with a slant angle θ in a region between root 122 and tip 124 can reduce mortality where fish 300 may be relatively likely to experience a fatal impact.

In some embodiments, for example, as shown in FIG. 1C, slant angle θ at tip 124 of blade 922 can be smaller than slant angle θ at root 122 and/or a location between root 122 and tip 124. The slant angle of leading edge 126 of blade 120 at tip 124 can be, for example, about 20 degrees to about 90 degrees, such as about 25 to about 45 degrees.

In some embodiments, leading edge 126 can be slanted at root 122. The slant angle of leading edge 126 of blade 120 at root 122 can be, for example, about 10 degrees to about 90 degrees, such as about 25 to about 45 degrees. In addition to improving survival of fish 300 impacting blade 120 at root 122, providing a slanted leading edge 126 at root 122 can also, for example, help to prevent build-up or accumulation of debris where root 122 of blade 120 meets hub 110.

In some embodiments, for example, as shown in FIG. 1C, leading edge 126 of blade 120 can be slanted such that leading edge 126 is arc-shaped. In other embodiments, leading edge 126 can have a C-shape, a semi-circular shape, a parabolic shape, a conic shape, a saddle shape, or some other shape.

In some embodiments, for example, as shown in FIG. 1C, leading edge 126 of blade 120 can curve toward trailing edge 128 of blade 120 near hub 110 such that leading edge 126 has a concave shape. This can allow, for example, smaller angles to be achieved at tip 124 while minimizing the cantilever or forward lean at the tip.

In some embodiments, leading edge 126 of blade 120 at root 122 can be slanted at a first angle θ, and leading edge 126 of blade 120 at tip 124 can be slanted at the same angle θ.

In some embodiments, root 122 of leading edge 126 of blade 120 is positioned along a radial axis 160 of runner 100, and tip 124 of leading edge 126 extends beyond radial axis 160 in circumferential direction 170. Thus, leading edge 126 of blade 120 can be cantilevered beyond the radial axis in the circumferential direction, also referred to as a forward lean.

As tip 124 at leading edge 126 extends farther beyond radial axis 160 in circumferential direction 170, a smaller angle can be achieved. This can result in a lower normal component of strike velocity w_{N} at impact. However, as the angle continues to decrease, the structural stiffness of the blade may also decrease. This can result in increased manufacturing costs to maintain minimum structural stiffness requirements for the blade. Structural stiffness can be required, for example, to retain tip 124 of blade 120 in the tight tolerances of housing of a turbine.

In some embodiments, runner 100 can include a rim connecting tips 124 of blades 120. This can, for example, reduce the instance of structural deflection.

In some embodiments, root 122 of leading edge 126 of blade 120 and tip 124 of leading edge 126 of blade 120 can both be positioned along radial axis 160.

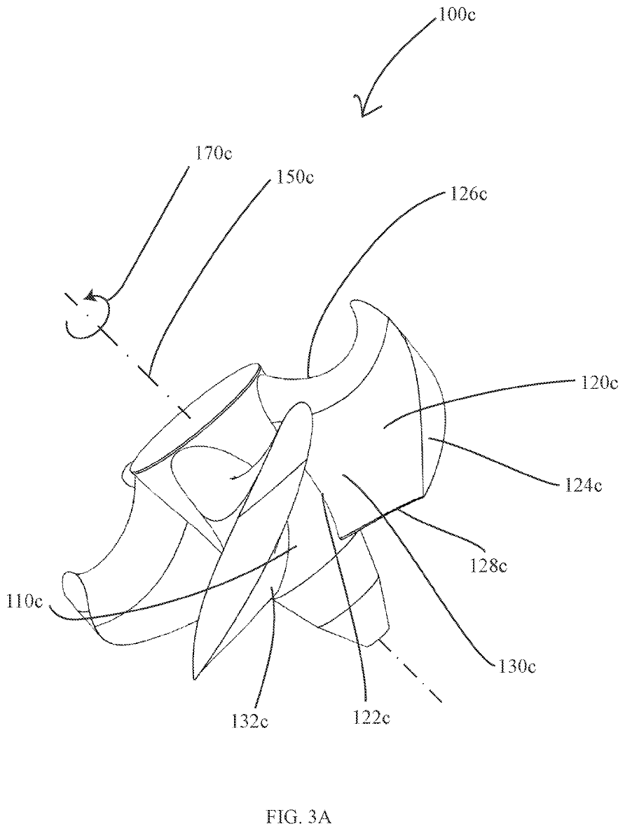

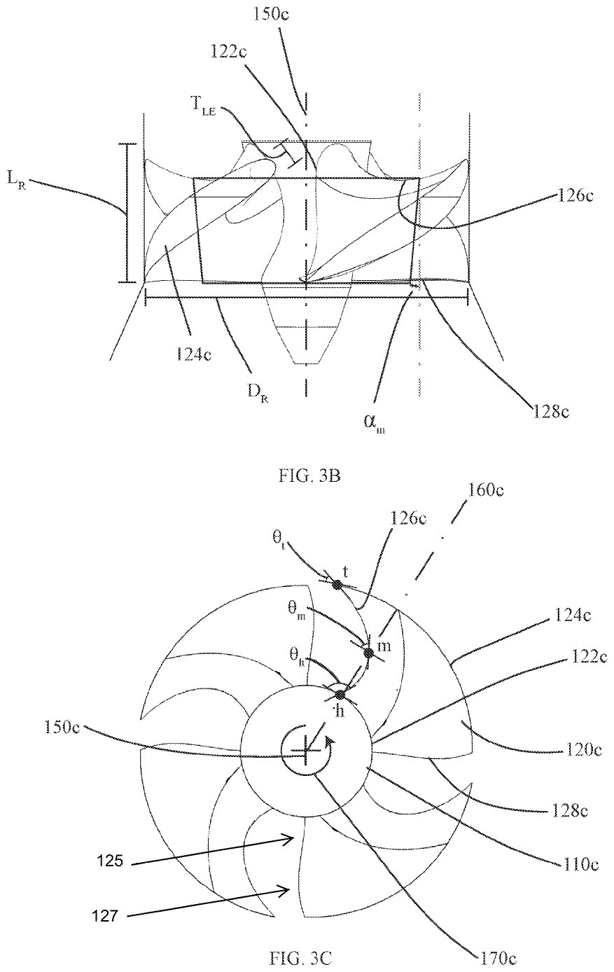

In some embodiments, for example, as shown in FIG. 3C, trailing edge 128 of a runner 100c can have an S-shape. A first portion 125 of the trailing edge can be concave, and a second portion 127 of the trailing edge (e.g., a portion of the trailing edge located farther from the hub than the first portion) can be convex. In some embodiments, a first portion of pressure surface 130 adjacent to the first portion of trailing edge 128 is concave, and a second portion of pressure surface 130 adjacent to second portion of trailing edge 128 (and located farther from the hub than the first portion of pressure surface 130) is convex. In some embodiments, suction surface 132 adjacent to trailing edge 128 is convex along a majority of trailing edge 128. In some embodiments, runner 100 is configured to rotate such that an orthogonal component of strike speed is about 7 m/s or less in order to allow for safe fish passage (e.g., for safe passage of salmonids). In some embodiments, runner 100 is configured to rotate such that an orthogonal component of strike speed is about 10 m/s or less in order to allow for safe fish passage (e.g., for safe passage of eels). By providing a slanted leading edge 126, the orthogonal component of strike speed is effectively reduced, allowing runner 100 to rotate at a higher speed to improve power specific speed and economic competitiveness of runner 100 while maintaining safe fish passage.

In some embodiments, for example as shown in FIG. 1C, blades 120 can be shaped such that blades 120 do not overlap one another when viewed along a shaft axis 150 of runner 100.

Runner 100 and/or blades 120 can be made of any suitable material and can be formed by any suitable process. In some embodiments, runner 100 and/or blades 120 are made of molded carbon/fiberglass and resin. In such embodiments, blade 120 can include a core composed of a lightweight foam. In some embodiments, runner 100 is composed of metal, such as bronze, stainless steel, or the like, and can be formed by castings that are machined to the final shape. In some embodiments, runner 100 and/or blades 120 are hollow. In some embodiments, runner 100 is composed of composites and is produced via conventional methods of composite construction. For example, runner 100 can have a sandwich composite construction or can include a shear web inside a structure, or can be made as a monocoque construction with thick walls. In some embodiments, runner 100 is composed of an elastomer or polymer, with reinforcements either locally or distributed throughout its interior.

Blade 120 can have a hybrid construction. In some embodiments, leading edge 126 of blade 120 is armored. Leading edge 126 can include a coating. Leading edge 126 can be metallic. In some embodiments, blade tips 124 are molded with a thick layer of ablative material such that blades tips 124 can wear into the inner diameter of a housing 104 of a turbine (shown, e.g., in FIG. 1B).

In some embodiments, a diameter D_{R} of runner 100 can be at least about 0.4 meters. In some embodiments, a diameter D_{R} of runner 100 can range from about 0.4 meters to about 7 meters, such as about 1 meter to about 5 meters.

The ratio of axial length L_{R} of runner 100 to diameter D_{R} of runner 100 at a downstream side of runner 100 can vary depending on the diagonal angle. For example, a runner with a relatively small mean diagonal angle (for example, about 1.5 degrees) can have a relatively large ratio L_{R}/D_{R} (for example, about 0.4 to about 0.6). As another example, a runner with a relatively large mean diagonal angle (for example, about 25 degrees) can have a relatively small ratio L_{R}/D_{R} (for example, about 0.25 to about 0.4).

In some embodiments, runner 100 is integrated into a turbine 200 (shown, for example, in FIG. 1B). In FIG. 1B, shaft axis 150 is vertical with respect to ground.

However, in other embodiments, shaft axis 150 can be horizontal with respect to ground or can be at an angle between horizontal and vertical with respect to ground.

In some embodiments, turbine can include inlet and outlet elements commonly known. Inlet elements can include, for example, a spiral or a semi-spiral. In some embodiments, an inlet of turbine 200 is intended to be connected to the discharge of a pressurized pipe, penstock, or scroll case. Outlet elements can include, for example, a draft tube. The draft tube can have changes in cross sectional area appropriate to recover velocity head. The draft tube can be straight, or have bends, as is appropriate given characteristics of the hydropower plant.

In operation, water can flow into turbine, pass through a stage of guide vanes (which can be fixed in pitch, or adjustable, as required by the application) if guide vanes are present, pass through runner 100, and exit to a tailwater or an outlet pipe which communicates the discharged water to a tailwater.

In some embodiments, turbine operates at a head of at least 1 meter. In some embodiments, turbine operates at a head of at least 10 meters. In some embodiments, turbine operates at a head of at least 20 meters. In some embodiments, turbine operates at a head of at least 30 meters. In some embodiments, turbine operates at a head of at least 40 meters.

In some embodiments, runner 100 can be incorporated into turbine, and turbine can be part of a hydroelectric installation including several turbines.

In some embodiments, runner 100 is retrofit into an existing turbine or hydroelectric installation. Runner 100 may be used to rehabilitate, update or modernize an existing turbine or hydroelectric installation. In a retrofit, it is often important to minimize changes to existing civil works and electrical infrastructure. For example, a retrofit may have strict constraints to utilize an existing generator at a fixed shaft speed, to install the runner at a pre-determined elevation with respect to tailwater elevation, or to operate with an existing intake chamber, discharge ring, or draft tube, all of which tightly constrain the design envelope in which a fish-safe runner can be created.

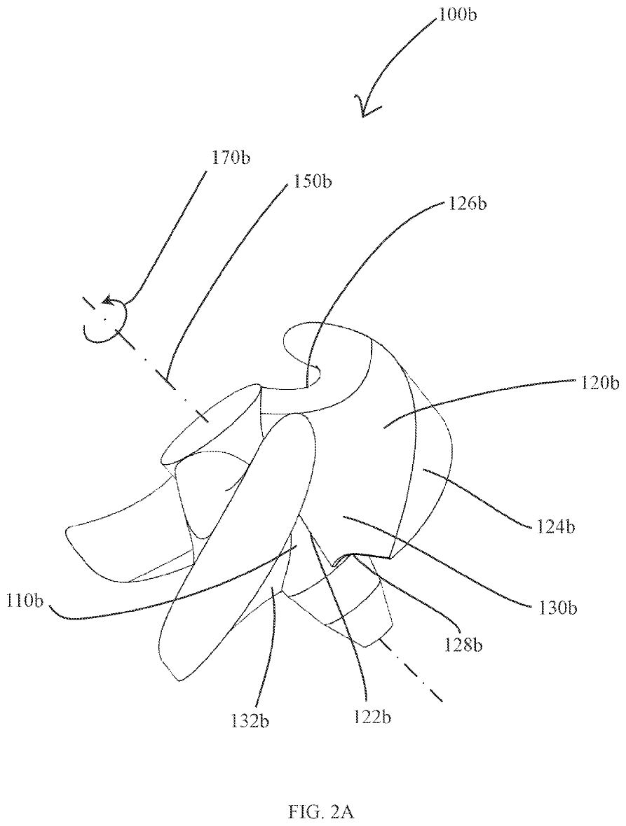

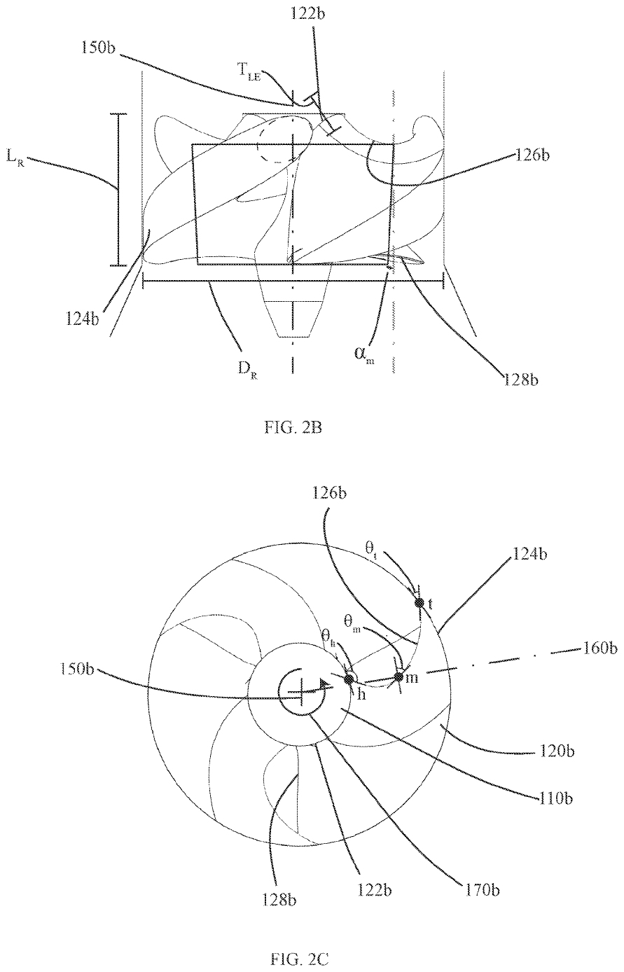

FIGS. 2A-2C show a runner 100b according to another embodiment. FIG. 2A shows a perspective view of runner 100b, FIG. 2B shows a side view of runner 100b, and FIG. 2C shows an upstream view of runner 100b.

Runner 100b may include some or all of the features, structures, or characteristics discussed above with respect to runner 100. For example, runner 100b may include hub 110b, blades 120b, roots 122b, tips 124b, leading edges 126b, trailing edges 128b, pressure surface 130b, and suction surfaces 132b, which may include some or all of the features, structures, or characteristics discussed above with respect to hub 110, blades 120, roots 122, tips 124, leading edges 126, trailing edges 128, pressure surface 130, and suction surfaces 132.

In the embodiment shown in FIGS. 2A-2C, runner 100b has a tapered hub 110b. Runner 100b has blade tips 124b that define a generally cylindrical outer shape. A surface swept from the circle intersecting the leading edge midpoints of blades 120b to the circle intersecting the trailing edge midpoints of blades 120b has a frustoconical shape. With reference to FIG. 2C, runner 100 b has a mean diagonal angle αₘ of about 2 degrees.

Runner 100b may, for example, be suitable in conditions involving a cylindrical turbine housing and operating at a hydropower plant with head between 2 m and 10 m.

FIGS. 3A-3C show a runner 100c according to another embodiment. FIG. 3A shows a perspective view of runner 100c, FIG. 3B shows a side view of runner 100c, and FIG. 3C shows an upstream view of runner 100c.

Runner 100c may include some or all of the features, structures, or characteristics discussed above with respect to runner 100. For example, runner 100c may include hub 110c, blades 120c, roots 122c, tips 124c, leading edges 126c, trailing edges 128c, pressure surface 130c, and suction surfaces 132c, which may include some or all of the features, structures, or characteristics discussed above with respect to hub 110, blades 120, roots 122, tips 124, leading edges 126, trailing edges 128, pressure surface 130, and suction surfaces 132.

In the embodiment shown in FIGS. 3A-3C, runner 100c has a tapered hub 110c. Runner 100c has blade tips 124 that define an outer frustoconical shape that tapers from an inlet side of runner 100 to an outlet side of runner 100. A surface swept from the circle intersecting the leading edge midpoints of blades 120c to the circle intersecting the trailing edge midpoints of blades 120c has a frustoconical shape. With reference to FIG. 3C, runner 100c has a mean diagonal angle αₘ of about 6 degrees.

Runner 100c may, for example, be suitable in conditions involving a turbine housing having a frustoconical shape and operating at a hydropower plant with head between 10 m and 30 m.

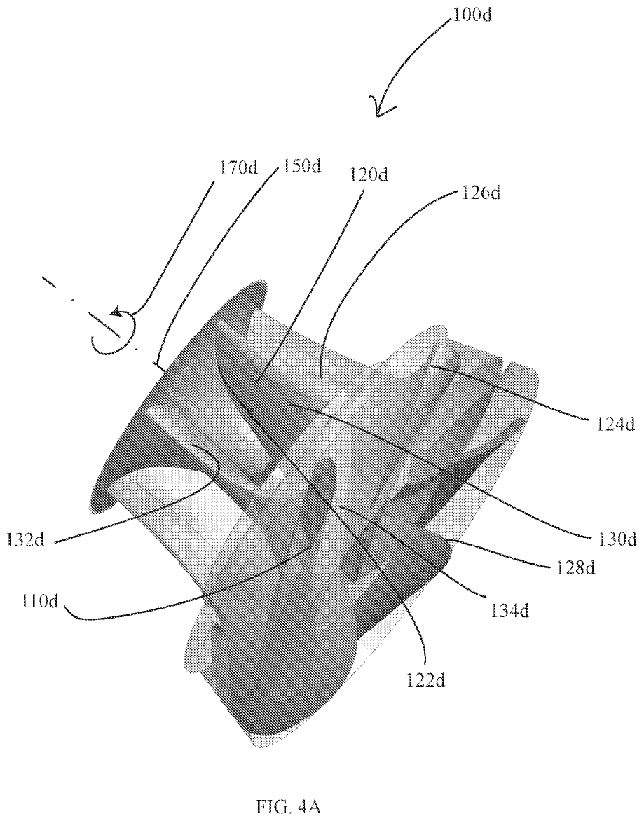

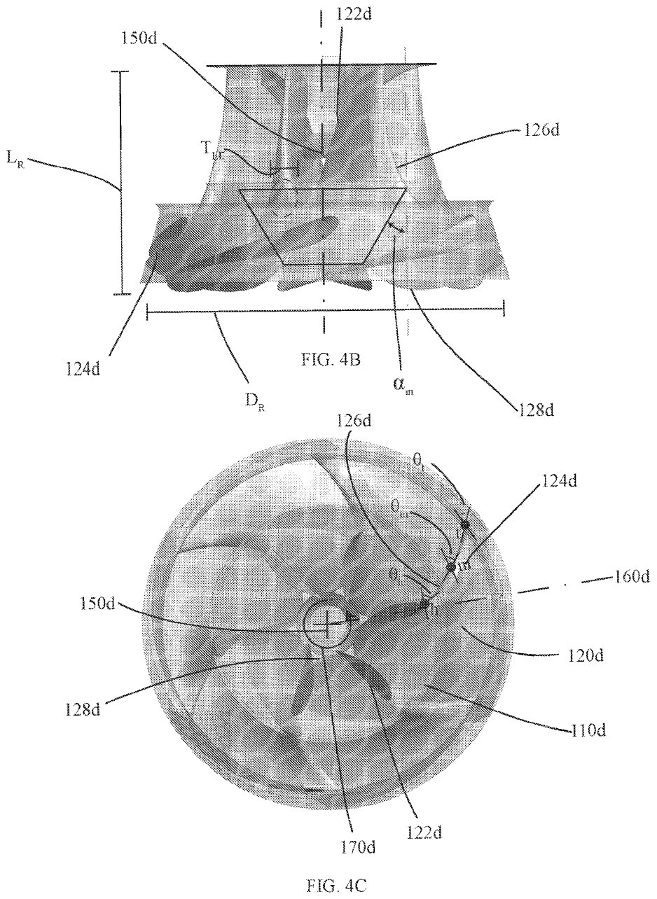

FIGS. 4A-4C show a runner 100d according to another embodiment. FIG. 4A shows a perspective view of runner 100d, FIG. 4B shows a side view of runner 100d, and FIG. 4C shows an upstream view of runner 100d.

Runner 100d may include some or all of the features, structures, or characteristics discussed above with respect to runner 100. For example, runner 100d may include hub 110d (also known as a crown), blades 120d, roots 122d, tips 124d, leading edges 126d, trailing edges 128d, pressure surfaces 130d, and suction surfaces 132d, which may include some or all of the features, structures, or characteristics discussed above with respect to hub 110, blades 120, roots 122, tips 124, leading edges 126, trailing edges 128, pressure surface 130, and suction surfaces 132.

In the embodiment shown in FIGS. 4A-4C, runner 100d is a Francis-type runner. Runner 100d may have a tapered hub 110d (also known as a crown) and blade tips 124d joined by a rim 134d. Blade tips 124d terminate in a surface of revolution which has an increasing cross section when measured along shaft axis 150d. A surface swept from the circle intersecting the leading edge midpoints of blades 120d to the circle intersecting the trailing edge midpoints of blades 120d has a frustoconical shape. With reference to FIG. 4B, the mean diagonal angle αₘ of runner 100d is about 17 degrees

In the embodiment illustrated in FIGS. 4A-4C, runner 100d has a runner diameter D_{R} at a downstream side of runner 100d. Runner 100d may be designed across a wide range of sizes. The runner diameters D_{R} may range from about 0.5 meters to about 7 meters, and may range from 1 meter to about 6 meters. The runner diameter may be smaller where the turbine has fixed pitch blades. In some examples, runner diameter D_{R} can be approximately 3.6 meters. In some embodiments, the mean radius of the leading edge (i.e., the radius of the circle intersecting the leading edge midpoints of blades 120d) is approximately 2 meters, the mean radius of the trailing edge (i.e., the radius of the circle intersecting the trailing edge midpoints of blades 120d) is approximately 1.6 meters, the axial displacement between these two mean circles is approximately 0.8 meters, and the mean diagonal angle αₘ of runner 100d is about 17 degrees. The leading edge thickness of blades 120d of runner 100d near tips 124d of blades 120d is approximately 0.28 m, or 0.07 D_{R} (i.e., the runner diameter D_{R}, multiplied by 0.07). The leading edge thickness of blades 120d near roots 122d of blades 120d is approximately 0.15 m, or 0.04 D_{R}. Leading edges 126d at tips 124d have a slant angle θ of approximately 45 degrees.

Runner 100d may, for example, be suitable in conditions involving applications normally considered for Francis turbines and operating at a hydropower plant with head between 8 m and 40 m.

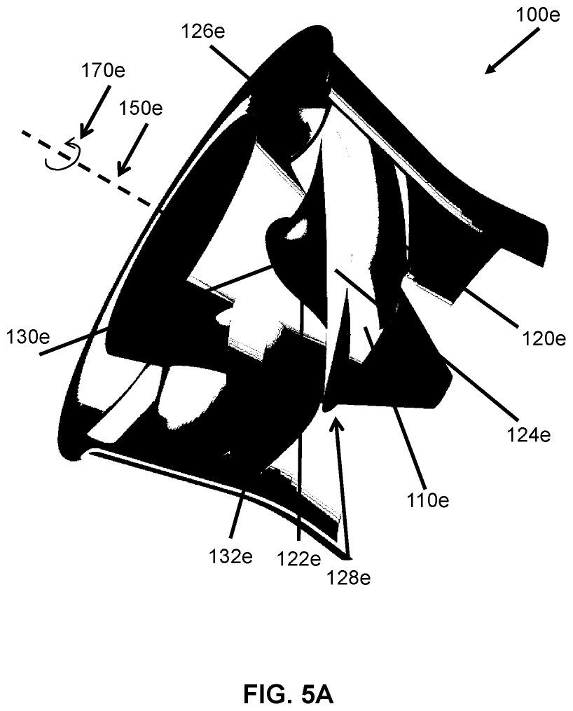

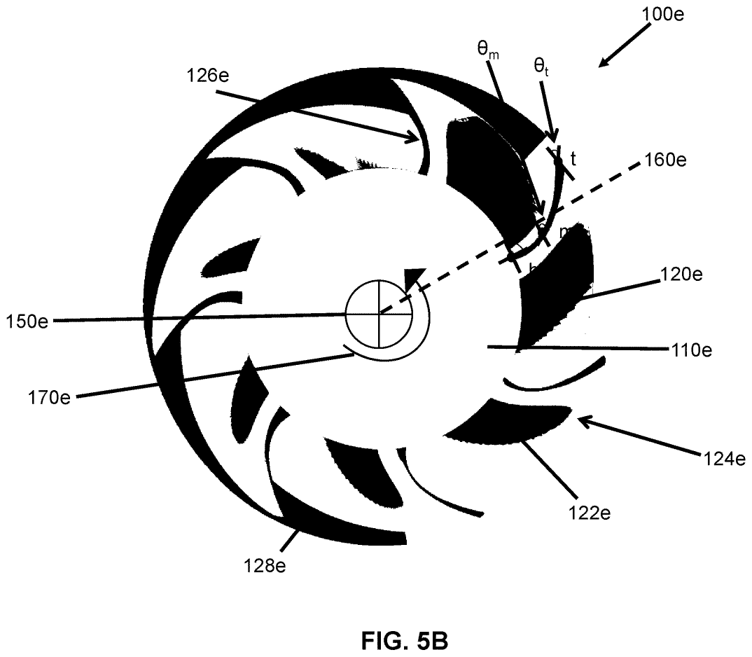

FIGS. 5A-5B show a runner 100e according to some embodiments. FIG. 5A shows a perspective view of runner 100e, and FIG. 5B shows an upstream view of runner 100e. Runner 100e may include some or all of the features, structures, or characteristics discussed above with respect to runner 100, as shown in FIG. 1A-1C. For example, runner 100e may include hub 110e, blades 120e, roots 122e, tips 124e, leading edges 126e, trailing edges 128e, pressure surface 130e, and suction surfaces 132e, which may include some or all of the features, structures, or characteristics discussed above with respect to hub 110, blades 120, roots 122, tips 124, leading edges 126, trailing edges 128, pressure surface 130, and suction surfaces 132.

Runner 100e in FIG. 5A differs from runner 100 of FIGS. 1A-C in several respects as described herein. Runner 100e may include a different number of blades. Runner 100 has four blades, whereas runner 100e has seven blades as best shown in FIG. 5B. Runner 100e may have different numbers of blades, such as five to ten blades. Fish safety may be improved by a runner having a smaller number of blades than a traditional turbine runner. The smaller number of blades helps to decrease fish strike probability, as high fish strike probability is correlated with higher fish injury and mortality. Further, fish safety is improved by forming the runner with a large leading edge thickness, as described herein. As the thick blades occupy more space within the turbine, reducing the number of blades increases helps to increase the space available for flow of water through the turbine to improve performance.

In the embodiment shown in FIGS. 5A-5B, runner 100e may have a tapered hub 110e. Hub 110e may taper from upstream end to downstream end of runner 100e. Runner 100e may have blade tips 124e that define a generally cylindrical outer shape. A surface swept from the circle intersecting the leading edge midpoints of blades 120e to the circle intersecting the trailing edge midpoints of blades 120e may have a frustoconical shape. Runner 100e may, for example, be suitable in conditions involving a cylindrical turbine housing and operating at a hydropower plant with head between 2 m and 10 m.

In the runner 100e of FIGS. 5A-5B, the mean diagonal angle is shallower than the mean diagonal angle of runner 100 in FIGS. 1A-1C. The shallower mean diagonal angle allows for a larger blade surface area for a runner having the same ratio of hub diameter to tip diameter. The shallower angle and larger surface area helps to improve pressure distribution through the runner, minimizing or reducing risk of cavitation, and thereby improving fish safety through the runner. In some embodiments, the mean diagonal angle is in a range of about 9 to about 23 degrees.

The shape of the runner 100e may define an angle of fluid flowing through the turbine. For example, leading edge 126e of runner 100e may have a concave shape, may be thick relative to trailing edge 128e, and tip 124 of leading edge 126e may be twisted, which may give fluid flowing through the turbine a diagonal flow, as illustrated in FIGS. 5A-B. In some examples, a surface of tip 124e may be positioned more downstream towards the leading edge, and as tip 124e extends towards trailing edge 128e, the surface of tip 124e may twist such that the surface faces more upstream at the trailing edge 128e. In some examples, a portion of trailing edge 128e may bow downstream relative to tip 124e of trailing edge 128e. A middle portion of trailing edge 128e may be further downstream than tip 124e or root 122e of trailing edge 128e.

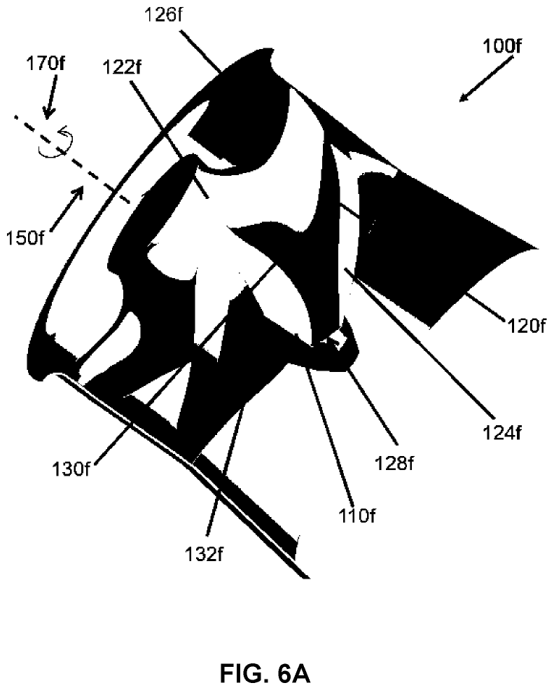

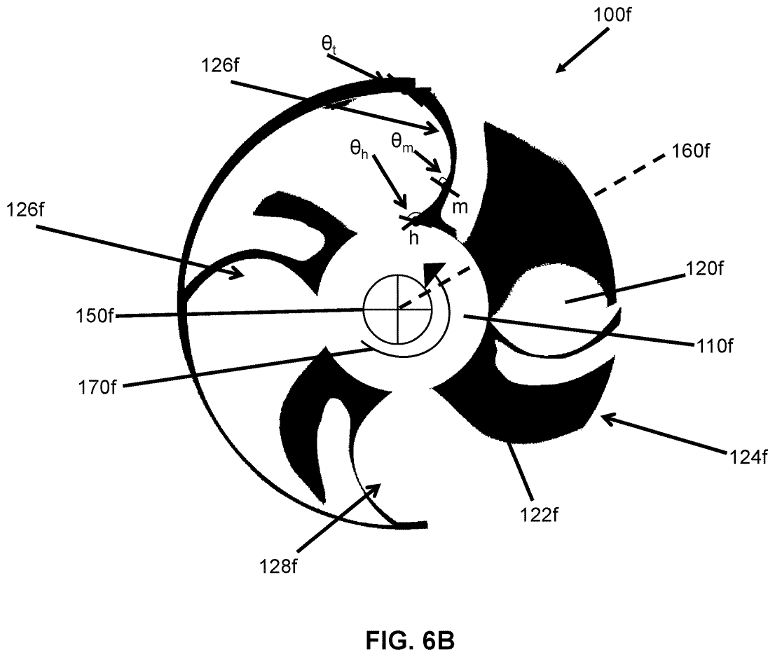

FIGS. 6A-6B show a runner 100f according to some embodiments. FIG. 6A shows a perspective view of runner 100f, and FIG. 6B shows an upstream view of runner 100f. Runner 100f may include some or all of the features, structures, or characteristics discussed above with respect to runner 100. Particularly, runner 100f may have similar features as described with respect to FIGS. 2A-3C. For example, runner 100f may include hub 110f, blades 120f, roots 122f, tips 124f, leading edges 126f, trailing edges 128f, pressure surface 130f, and suction surfaces 132f, which may include some or all of the features, structures, or characteristics discussed above with respect to hub 110, blades 120, roots 122, tips 124, leading edges 126, trailing edges 128, pressure surface 130, and suction surfaces 132.

In the embodiment shown in FIGS. 6A-6B, runner 100f may have a tapered hub 110f. Runner 100f may have blade tips 124f that define a generally cylindrical outer shape. A surface swept from the circle intersecting the leading edge midpoints of blades 120f to the circle intersecting the trailing edge midpoints of blades 120f may have a frustoconical shape. Runner 100f may, for example, be suitable in conditions involving a cylindrical turbine housing and operating at a hydropower plant with head between 2 m and 10 m.

Similar to runner 100e, the shape of runner 100f may define an angle of fluid flowing through the turbine. Leading edge 126f of runner 100f may have a concave shape, and leading edge 126f may be thick relative to trailing edge 128f. Tip 124 of leading edge 126f may be twisted. FIGS. 5A-5B show a runner 100e with seven blades 120e, and FIGS. 6A-6B show a runner 100f with four blades 120f. Runners with fewer blades may have more spacing between a trailing edge and the leading edge of adjacent blades. For example, FIG. 6B shows a runner 100f with four blades 120f, and a space is formed between leading edge 126f of blade 120f and trailing edge of an adjacent blade.

Blade 120f of runner shown in FIG. 6 may have a smaller tip chord to root chord ratio than blades 120b and 120c of FIGS. 2-3. In other words, the root chord is proportionally longer for blade 120f than blades 120b and 120c. Trailing edge 128f at root 122f extending further downstream may result in the proportionally longer root chord for blade 120f compared to blades 120b and 120c. The ratio of tip chord to root chord in FIG. 6 may be in a range of 1.3 to 1.7, whereas the ratio of tip chord to root chord in runner shown in FIGS. 2-3 may be in a range of 1.9 to 2.5. An increased root chord length results in better pressure distribution along blades 120f, which results in increased efficiency. As shown, for example, in FIG. 6B, blade 120f of runner 100f can have a leading edge 126f that is slanted at an angle θ at one or more locations (e.g., locations t, m, h) along leading edge 126f. A curve can be drawn along the apex of the stagnation region of the blade from hub to tip, defining the leading edge of the blade. A tangent line drawn at any point along this curve can be measured relative to a cylindrical surface, coaxial with the turbine runner rotation axis, which intersects the point. The slant angle is measured between the tangent line, and a vector lying on the cylindrical surface, perpendicular to the leading edge and coincident with the leading edge intersection point.

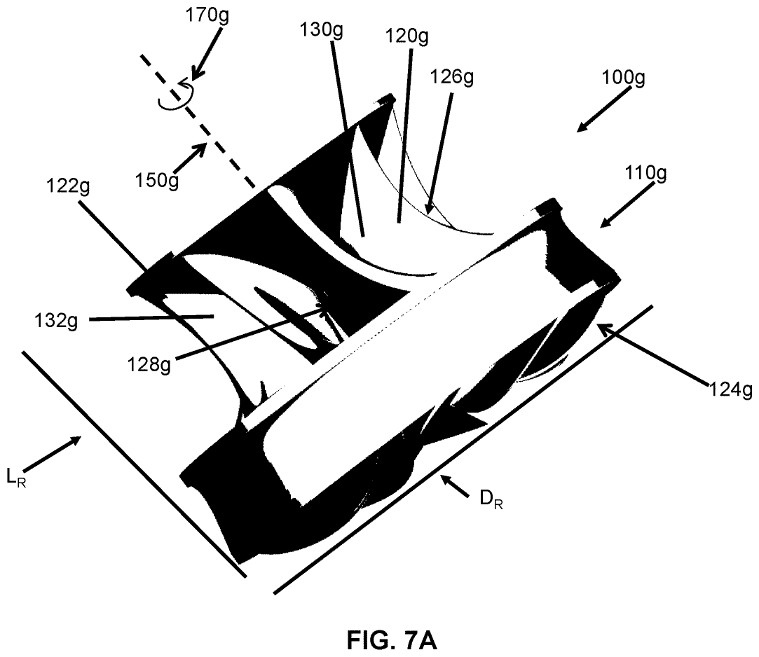

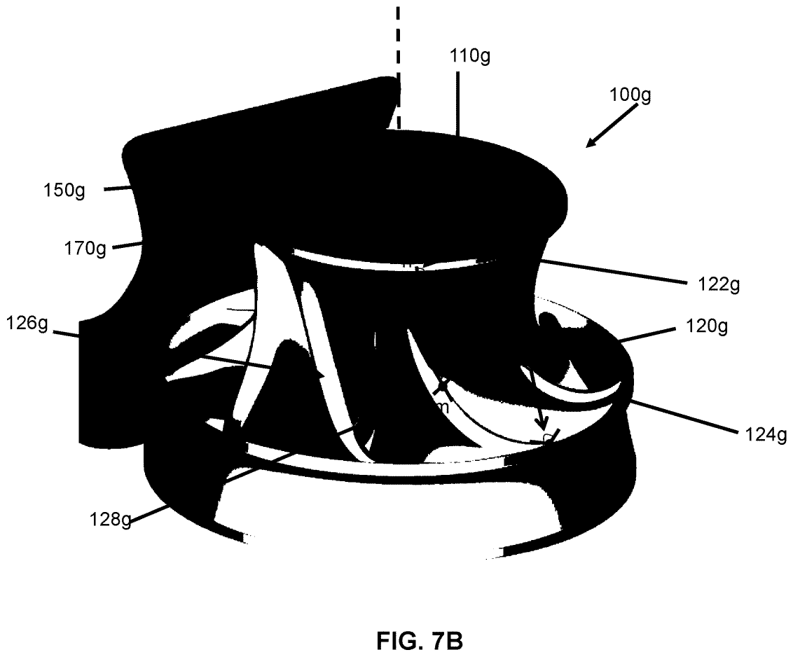

In the embodiment shown in FIGS. 7A-7B, runner 100g is a Francis-type runner. Runner 100g may have similar features as described above with respect to runner of FIGS. 4A-4B. Runner 100g may have a tapered hub 110g (also known as a crown). Runner 100g may have blade tips 124g joined by a rim 134g. However, in some embodiments, runner 100g does not include a rim 134g. Blade tips 124g terminate in a surface of revolution which has an increasing cross section when measured along shaft axis 150g. A surface swept from the circle intersecting the leading edge midpoints of blades 120g to the circle intersecting the trailing edge midpoints of blades 120d has a frustoconical shape.

In the embodiment illustrated in FIGS. 7A-7C, runner 100g has a runner diameter D_{R} of approximately 4 meters to 6 meters, and may have a diameter of for example, 3.6 meters. In some embodiments, leading edge 126g may be approximately 250 mm to 280 mm thick. For example, for a runner having a diameter of 3.6 meters, may have a ratio of leading edge thickness t_{LE} to runner diameter D_{R} (t_{LE}/D_{R}) of about 0.07 to 0.08.

In some embodiments described herein, runners may have a blade with a trailing edge extending from a root to a tip of the blade, wherein the trailing edge at the tip is located upstream of the trailing edge at the root.

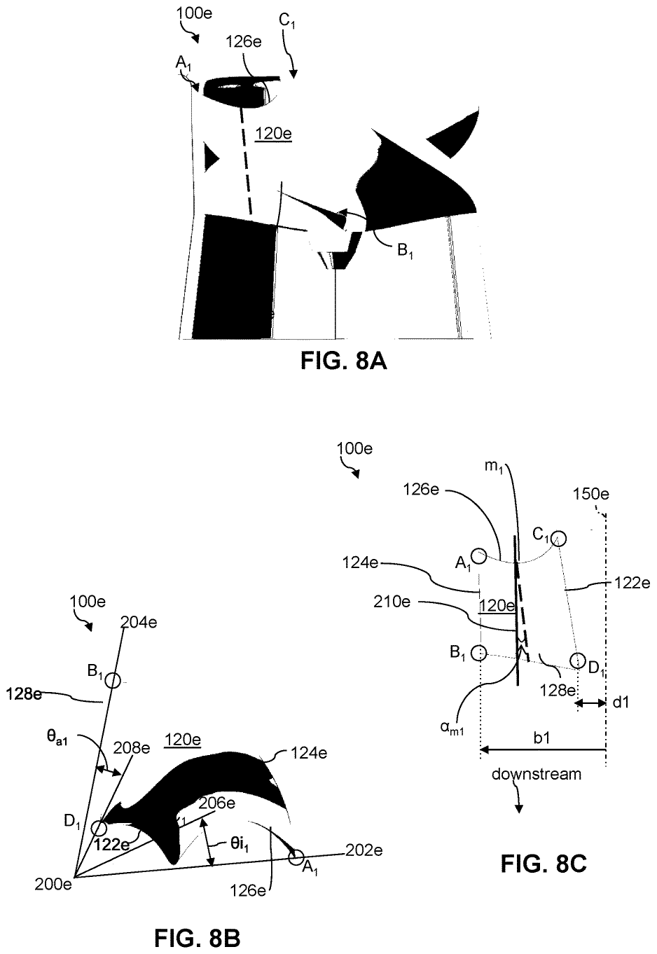

FIG. 8A shows a side view of runner 100e having a trailing edge at the tip downstream of the trailing edge at the root. Runner 100e has a blade with a point A1 at tip 124e of leading edge 126e, a point B1 at tip 124e of trailing edge 128e, and a point C1 at root 122e of leading edge 126e. FIG. 8B is a cross-sectional view of blade 120e taken at E-E in FIG. 8A. As illustrated in FIG. 8B, runner 100e may have points A1, B1, C1, and may have a point D1 located at trailing edge 128e of root 122e. FIG. 8B illustrates an origin 200e which corresponds to an axis of rotation of the runner 100e. An axis 202e extends from origin 200e through A1, an axis 204e extending through B1, an axis 206e extending through C1 and an axis 208e extending through D1. Angle, θₐ₁ may be defined between axis 204e and 208e. FIG. 8B also illustrates that angle θᵢ₁ may be defined between axis 202e and axis 206e, and angle θᵢ₁ may be larger than angle θₐ₁. Angle θᵢ₁ may be between about 20 and about 50 degrees. Angle θᵢ₁ is related to the extent of the cantilever or forward lean of blade 120e. In some examples, an angle θᵢ₁ within this range may enable blade 120e to have a range of stagger angles (i.e., the angle between a chord line of a blade and the axial flow direction, wherein a stagger angle of 0 degrees is parallel to flow) from root 122e to tip 124e. Angle, θaᵢ₁ may be between approximately 8 and about 20 degrees, which may allow an appropriate range of root chord and root stagger in conjunction with tip stagger and leading edge 126e forward lean.

FIG. 8C is an axial section view of blade 120e of runner 1003 showing an area or section swept by the runner, which may also be referred to herein as a “meridional” cross sectional view. The axial section, may refer to an area swept by the blade when viewed along an axis perpendicular to the shaft axis (i.e., when the runner is viewed from the side). Runner 100e has a blade 120e with a midline m1 defined as a middle portion between root 122e and tip 124e. For example, midline m1 may intersect a midpoint between points A1 and C1 on leading edge 126e, and a midpoint between points B1 and D1 along trailing edge 128e. In some examples, point C1 may be located upstream of point A1, and both points A1 and C1 may be located upstream of points B1 and D1. Point D1 is arranged downstream of point B1. As a result, the chord length C1-D1 is long relative to a blade having D1 upstream of B1. This increases the length of the blade and surface area which helps to improve pressure distribution through the runner and improves fish safety.

Points A1 and B1 may be located approximately the same distance from shaft axis 150e, and both points A1 and B1 may be located further from shaft axis 150e than points C1 and D1. Point C1 may be located further from shaft axis 150e than point D1. In the example of FIG. 8C, the leading edge 126e may be concave. D1 may be located a distance d1 from shaft axis 150e, and B1 may be located a distance b1 from shaft axis 150e. A ratio of d1 to b1 (i.e., d1/b1) may be between 0.15-0.35.

As illustrated in FIG. 8C, the distance between point A and point B may be smaller than the distance between point C and point D. In other words, the length of blade 120e at tip 124e (i.e., the surface between points A and B) may be smaller than the length of blade 120e at root 122e (i.e., the surface between points C and D).

A mean diagonal angle αₘ₁ may be defined as the angle between midline m1 and a line 210e parallel to shaft axis 150e, where the line 210e intersects midline at leading edge 126e. The mean diagonal angle αₘ₁ may be between about 2 and about 15 degrees. In some examples, the mean diagonal angle αₘ₁ may be between about 2 to about 10 degrees.

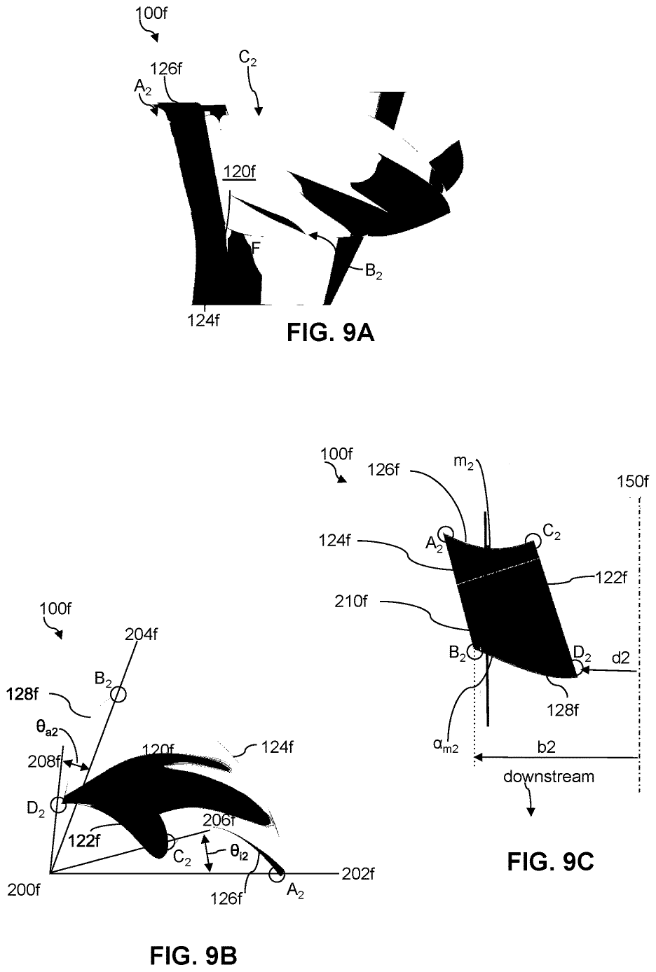

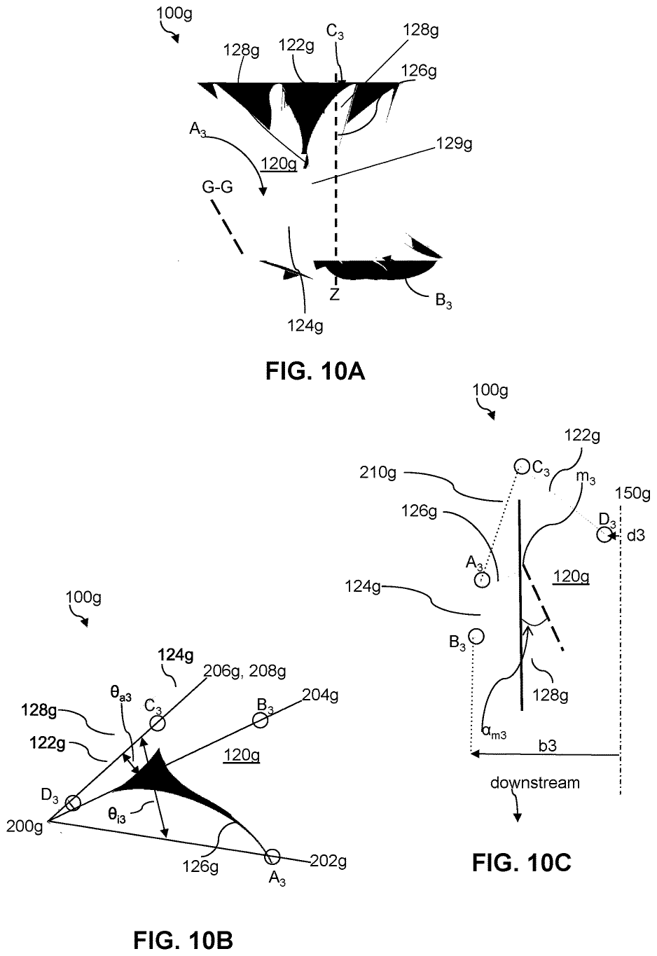

FIG. 9A shows a side view of a runner 100f. Runner 100f can include an outer rim connecting blade 120f tips 124f around a circumference of runner 100f. A mean diagonal angle αₘ₂ of runner 100f may be defined as the distance between midline m2 and a line 210f parallel to shaft axis 150f, where the line 210f intersects midline at leading edge 126f. The mean diagonal angle αₘ₂ of runner 100f may be greater than mean diagonal angle αₘ₁, but may be less than a mean diagonal angle αₘ₃ defined below and shown in FIG. 10C. The mean diagonal angle αₘ₂ may be between about 9 and about 23 degrees. An angle 60 ₘ₃ within this range may allow the blade to have a longer chord length, which increases surface area of the blade. This may help to improve pressure distribution, and maintains efficiency of the turbine.

Runner 100f may have more blades than runner 100g, and the blades in runner 100f may have a greater mean diagonal angle. Runner 100f has a point A2 at tip 124f of leading edge 126f, a point B2 at tip 124f of trailing edge 128f, and a point C2 at root 122f of leading edge 126f. FIG. 9B is a cross-sectional view of blade 120f taken at F-F in FIG. 9A. As illustrated in FIG. 9B, runner 100f may have points A2, B2, C2, and may have a point D2 located at trailing edge 128f of root 122f. An origin 200f corresponding to a shaft axis around which runner 100f rotates. An axis 202f may extend from origin through A2, an axis 204f extending through B2, an axis 206f extending through C2, and an axis 208f extending through D2. Angle, θₐ₂ may be defined between axis 204f and 208f. Angle θₐ₂ may be between approximately 8 to approximately 20 degrees. Angle θᵢ₂ may be defined between axis 202f and axis 206f, and angle θᵢ₂ may be larger than angle θₐ₂. Angle θᵢ₂ may be between approximately 25 to approximately 35 degrees.

FIG. 9C is an axial section view of blade 120f, which may be referred to as a meridional cross sectional view. FIG. 9C shows a midline m2 defined as a middle portion between root 122f and tip 124f. For example, midline m2 may intersect a midpoint between points A2 and C2 on leading edge 126f and a midpoint between points B2 and D2 along trailing edge 128f. In some examples, point A2 may be located upstream of point C2, or points A2 and C2 may be located approximately the same plane along a shaft axis 150f. Points A2 and C2 may be located upstream of points B2 and D2. Point B2 may be arranged upstream of point D2. In this way, the chord length and surface area of the blade is increased relative to a blade having D2 upstream of B2, without increasing the runner diameter.

Point A2 may be farther from shaft axis 150f than point B2, and both points A2 and B2 may be located further from shaft axis 150f than points C2 and D2. Point C2 may be located further from shaft axis 150f than point D2. In the example of FIG. 9C, the surface shape of leading edge 126f may be concave and the surface shape of trailing edge 128f may be convex. D2 may be located a distance d2 from shaft axis 150f, and B2 may be located a distance b2 from shaft axis 150f. A ratio of d2 to b2 (i.e., d2/b2) may be between approximately 0.25-0.5.

FIG. 10A shows a side view of a runner 100g which is a Francis type runner. Runner 100g may have a plurality of blades 122g. Each blade 120g may have a leading edge 126g with a first portion 128g adjacent root of blade and a second portion 129g adjacent tip of blade 120g. As shown in FIG. 10A, second portion 129g slopes or curves forwardly of vertical axis Z. In contrast, the runner 100d of FIGS. 4A-4C has a leading edge 126d at root 122d that is approximately in-line with shaft axis 150d of runner 100d. Blade 120 of FIG. 4B may have a smaller angle θᵢ than angle θᵢ₃ of blade 120g, shown in FIG. 10B. Angle θᵢ may be between about 23 to about 35 degrees, and angle θᵢ₃ may be between about 50 and about 60 degrees. Angles outside of this range may only achieve an incremental amount of fish safety while making the blades significantly more difficult to manufacture. Blades 120g of FIG. 10B also have a greater forward lean, i.e., a greater cantilevered leading edge 126d, relative to blades 120d in FIG. 4B. Blades with a larger forward lean generally achieve better fish strike survival along the leading edge, and provides for a more efficient pressure distribution along the blade, when compared to blades with a smaller forward lean.

Runner 100g has a point A3 at tip 124g of leading edge 126g, a point B3 at tip 124g of trailing edge 128g, and a point C3 at root 122g of leading edge 126g. FIG. 10B is a cross-sectional view of blade 120g taken at G-G of FIG. 10A. As illustrated in FIG. 10B, runner 100g may have points A3, B3, C3, and may have a point D3 located at trailing edge 128g of root 122g. An origin 200g may correspond to a shaft axis of runner 100g. An axis may be defined by the intersection of origin and a line 202g extending through A3, an axis 204g extending from origin through B3, an axis 206g extending from origin through C3, and an axis 208g extending from origin through D3. In some examples, axis 206g may extend through D3 and axis 208g may extend through C3 such that axes 206g, 208g are coextensive. In some examples, axis 206g may be slightly divergent from axis 208g. Angle, θₐ₃ may be defined between axis 204g and 208g. Angle θₐ₃ may be between about 15 and about 25 degrees. Angle θᵢ₃ may be defined between axis 202g and axis 206g, and angle θᵢ₃ may be larger than angle θₐ₃. Angle θᵢ₃ may be between approximately 30 and approximately 60 degrees. Angles θᵢ₃ outside of this range may only achieve an incremental amount of fish safety while making the blades more difficult to manufacture. Blades within this range also provide a more efficient pressure distribution along the blade, when compared to blades with outside of this range, leading to increased efficiency in the operation of the turbine.

FIG. 10C is an axial section view of blade 120g of FIG. 10A, which may also be referred to as a meridional cross sectional view. Blade 120g has a midline m3 defined as a middle portion between root 122g and tip 124g. For example, midline m3 may intersect a midpoint between points A3 and C3 on leading edge 126g and a midpoint between points B3 and D3 along trailing edge 128g. In some examples, point A3 may be located downstream of points C3 and D3, and point D3 may be downstream of point C3. Point B3 may be downstream of point A3. Points D3 and C3 may be upstream of midline m3 at leading edge 126g, and points A3 and B3 may be downstream of midline m3 at leading edge 126g.

Point A3 may be farther from shaft axis 150g than point B3, and both points A3 and B3 may be located further from shaft axis 150g than points C3 and D3. Point C3 may be located further from shaft axis 150g than point D3. In the example of FIG. 10C, the surface shape of leading edge 126g may be concave. In some examples, as the surface of leading edge 126g extends from midline m3 to point C3, the distance from shaft axis 150g may decrease, then increase. In other words, the surface of leading edge 126g may extend away from midline m3, and then curve back toward midline m3. The surface shape of trailing edge 128g may be convex. D3 may be located a distance d3 from shaft axis 150g, and B3 may be located a distance b3 from shaft axis 150g.

A mean diagonal angle αₘ₃ may be defined as the angle between midline m3 and a line 210g parallel to shaft axis 150g, where the line 210g intersects midline at leading edge 126g. The mean diagonal angle may be between about 25 and about 40 degrees. In some examples, the mean diagonal angle αₘ₃ may be between about 25 and about 35 degrees. Mean diagonal angle αₘ₃ may be larger than mean diagonal angles αₘ₂, and αₘ₁.

Any of the runners described herein may include a rim. Rim may be configured as a ring coupled to the tips of each of the blades. Rim contact an inner wall of turbine housing during operation of runner. The rim helps to improve rigidity of the runner and blades and may also help to prevent leakage of liquid around the blades.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

The breadth and scope of the present invention(s) should not be limited by any of the above-described exemplary embodiments, but should be defined only in accordance with the following claims and their equivalents.

Additional exemplary embodiments of the invention are described in the following clauses.

In some embodiments, a runner may have a hub and a plurality of blades extending from the hub, where a number of the plurality of blades is in a range of five to eight, and may be seven.

In some embodiments, a blade of a runner includes a midline extending from a midpoint of a leading edge of the blade to a midpoint of a trailing edge of the blade, wherein an angle between the midline and an axis parallel to a shaft axis of the runner is shallow and is about 2 to about 45 degrees, and may be in a range of about 2 and about 10 degrees.

In some embodiments, a blade of a runner includes a trailing edge extending from a root to a tip of the blade, wherein the trailing edge at the root is arranged downstream of the tip of the trailing edge.

In some embodiments, a chord length from a tip of the blade at the leading edge to the tip of the blade at the trailing edge is greater than a chord length from a root of the leading edge to the root of the trailing edge.

In some embodiments, a runner may include a rim comprising a ring coupled to a tip of each of the plurality of blades of the runner.

In some embodiments, a runner comprises a runner for a Francis turbine, and the runner comprises a hub and a plurality of blades connected to the hub, wherein a blade of the plurality of blades has a leading edge with a first portion and a second portion, wherein the first portion slopes or curves rearwardly of an axis parallel to a shaft axis of the runner, and a second portion that slopes or curves forwardly of the axis parallel to the shaft axis. The first portion is arranged closer to a root of the blade and the second portion is arranged closer to a tip of the blade.

What is claimed is:

1. A runner for a hydraulic turbine, comprising:
a hub; and
a plurality of blades extending from the hub,
wherein each blade of the plurality of blades comprises a root located at the hub, a tip opposite the root, a leading edge, and a trailing edge opposite the leading edge,
wherein the runner is configured to rotate about a rotation axis,
wherein each blade of the plurality of blades has a leading edge midpoint along the leading edge of the blade and a trailing edge midpoint along the trailing edge of the blade in a meridional section of the blade,
wherein a mean diagonal angle αₘ is defined between the rotation axis and a midline intersecting the leading edge midpoint and the trailing edge midpoint,
wherein at least one blade of the plurality of blades includes a ratio of a thickness of the leading edge to a diameter of the runner at a downstream side of runner, T_{LE}/D_{R}, that is greater than about 0.03, and
wherein for the at least one blade, the leading edge at the root is positioned along a radial axis of the runner and the leading edge at the tip is cantilevered beyond the radial axis in a circumferential direction of the runner.

2. The runner according to claim 1, wherein a maximum leading edge thickness of the at least one blade is at least approximately 50 mm.

3. The runner according to claim 1, wherein a maximum leading edge thickness of the at least one blade is at least approximately 100 mm.

4. The runner according to claim 1, wherein a maximum leading edge thickness of the at least one blade is at least approximately 200 mm.

5. The runner according to claim 1, wherein the mean diagonal angle αₘ is greater than 0 degrees and less than 90 degrees.

6. The runner according to claim 1, wherein the mean diagonal angle αₘ is between approximately 2 degrees and approximately 45 degrees.

7. The runner according to claim 1, wherein the mean diagonal angle αₘ is between approximately 9 degrees and approximately 23 degrees.

8. The runner according to claim 1, further comprising an outer rim connecting the blade tips around a circumference of the runner.

9. The runner according to claim 1, wherein the leading edge thickness of at least one of the blades at the blade tip is larger than the leading edge thickness at the blade root.

10. The runner according to claim 1, wherein the plurality of blades comprises three or more blades.

11. The runner according to claim 1, wherein the plurality of blades comprises five to ten blades.

12. The runner according to claim 1, wherein the leading edge of at least one of the blades is saddle-shaped.

13. The runner according to claim 1, wherein a portion of the leading edge at the blade tip of at least one of the blades is slanted forward in a direction of blade rotation.

14. The runner according to claim 1, wherein the portion of the leading edge at the blade tip is slanted at an angle ranging from about 20 degrees to about 90 degrees.

15. The runner according to claim 1, wherein the portion of the leading edge at the blade tip is slanted at an angle ranging from about 25 degrees to about 45 degrees.

16. The runner according to claim 1, wherein the trailing edge at the root is arranged downstream of the trailing edge at the tip.

17. The runner according to claim 1, wherein a diameter of the runner is between about 0.5 meters and 7 meters.

18. A turbine, comprising:
a housing defining an inlet and an outlet for a flow of water; and
the runner according to claim 1 positioned within the housing.
